(19) United States
(12) Patent Application Publication
(10) Pub. No.: US 2015/0269604 A1
(43) Pub. Date: Sep. 24, 2015

(54) OPTIMIZING MARKET RESEARCH USING MOBILE RESPONDENT OBSERVED ACTIVITIES DETERMINED FROM THIRD PARTY DATA SETS

(71) Applicant: RESEARCH NOW GROUP, INC., Plano, TX (US)

(72) Inventors: Eric SANDBERG, Plano, TX (US); Erik NEKEMAN, Plano, TX (US); Arthur E. STIVISON, Dallas, TX (US); Christopher J. MILLER, Toronto (CA); Palanivel KUPPUSAMY, Plano, TX (US); Maria DOMOSLAWSKA, Plano, TX (US)

(21) Appl. No.: 14/664,144

(22) Filed: Mar. 20, 2015

Related U.S. Application Data
(60) Provisional application No. 61/968,975, filed on Mar. 21, 2014.

(51) Int. Cl. G06Q 30/02; H04L 29/08

(52) U.S. Cl. CPC G06Q 30/0242; H04L 67/10; H04L 67/02; G06Q 30/0201

(57) ABSTRACT

A method and system platform for conducting mobile device market research into advertising effectiveness across varying media including mobile devices are disclosed. The method can include providing a previously defined data set comprising a list of mobile device respondents and related data. The method can include obtaining first party data for a subset of one or more mobile respondents from the list of mobile device respondents that participated in a predetermined activity. The method can include obtaining third party data for the subset of one or more mobile respondents that participated in the predetermined activity. The method can include correlating the first party data and the third party data. The method can include refining the previously defined data set based on the correlated first party data and third party data.

### BACKGROUND

Market research is an organized effort to gather information about markets or customers. Market research can include social and opinion research performed to systematically gather and interpret information about individuals or organizations using statistical and analytical methods and techniques of the applied social sciences to gain insight or support decision making. Viewed as an important component of business strategy, market research can be a key factor to obtain advantage over competitors. Market research provides important information to identify and analyze market need, market size, and competition. The advent of mobile devices, such as smart phones, presents new opportunities for enlisting mobile device users as mobile respondents in performing market research.

### BRIEF DESCRIPTION OF THE FIGURES

For a more complete understanding of the present disclosure, reference is now made to the following descriptions taken in conjunction with the accompanying figures, in which:

FIG. 1 shows a flowchart for a method of conducting mobile device market research into advertising effectiveness in accordance with an embodiment of the present disclosure;

FIG. 2 shows a chart of a first example in accordance with an embodiment of the present disclosure;

FIG. 3 shows a chart of a second example in accordance with an embodiment of the present disclosure;

FIG. 4 shows a chart of a first example in accordance with an embodiment of the present disclosure;

FIG. 5 shows a block diagram of a data transfer configuration in a system for conducting mobile device market research into advertising effectiveness in accordance with an embodiment of the present disclosure;

FIG. 6 illustrates functional blocks executed to perform a method of mobile respondent market research according to the concepts described herein.

### DEFINITIONS

A mobile device, as used herein, can refer to any portable computing and/or telecommunications device, including a mobile web connection, and/or a mobile application on a smartphone or tablet device.

A cookie, also known as an HTTP cookie, web cookie, Internet cookie, or browser cookie, refers to a small piece of data sent from a website and stored in a user's web browser while the user is browsing a website. Every time a user loads the website, the browser sends the cookie data back to the server to identify the user and/or notify the website of the user's previous activity. As referred to herein, a cookie may also be a small piece of data specific to the mobile device environment.

A first party cookie refers to a cookie that is stored by the same domain the user is currently visiting. That is, the cookie's domain name will match the domain name that is shown in the web browser's address bar.

A third party cookie, by comparison, refers to a cookie stored by a different domain than the domain the user is currently visiting. This is to say that a third party cookie belongs to domains different from the one shown in the address bar.

A tag refers to a script (often JavaScript) included in advertisements or website data that a server sends along with the ad or website data. The tag is functional to check if a given cookie is already stored by a given user's mobile device, or to check on whether a particular action can be executed.

A beacon refers to a script similar to a tag that also enables setting of cookie.

A container tag refers to a script that is included in advertisements or website data that a server sends along with the ad or website data that aggregates a plurality of individual tags together.

A pixel refers to an image embedded in a web page or email, which unobtrusively (usually invisibly) allows checking that a user has accessed the content. A pixel can be used similarly to the manner in which tags are used, and when the pixel is loaded, a call is made to the server which may also execute a script or action.

An advertising ID refers to a unique identifier associated to each individual mobile device that can be used to determine what mobile device has been exposed to advertising, even from within a mobile device application. Various types of advertising IDs may include (even historically) Android ID, Universal Device ID (UDID), Identifier for Advertising (IDFA), Google Advertising ID, Identifier For Vendor (IDFV), Windows Advertising ID, and additional like identifiers used similarly but as of yet unnamed.

An iBeacon refers to an Apple hardware technology that enables a smart phone or other device to perform certain predetermined actions when in close proximity to the Apple hardware. iBeacon uses a protocol for opt-in push notifications and location-based services that takes advantage of the way Bluetooth Low Energy (BLE) allows wireless devices to connect without human intervention. iBeacon, which specifies how BLE connection requests should be sent, is compatible with iPhone 4S or later, iPad third generation or later, iPad mini and iPod Touch fifth generation or later. The iBeacon continuously scans for iOS smartphones and tablets that have Bluetooth open and are running the iBeacon's compatible mobile app. When such a device comes within range, the iBeacon sends a connection request to wake up the app. The format of the request provides the app with the information it needs to push highly targeted information to the device in real time.

An impression tag refers to a feedback script that executes when a (mobile) device user has been exposed (or partially exposed) to an advertisement.

### DETAILED DESCRIPTION

It is to be understood that the following disclosure describes several exemplary embodiments for implementing different features, structures, or functions of the invention. Exemplary embodiments of components, arrangements, and configurations are described below to simplify the present disclosure; however, these exemplary embodiments are provided merely as examples and are not intended to limit the scope of the invention. Additionally, the present disclosure may repeat reference numerals and/or letters in the various exemplary embodiments and across the Figures provided herein. This repetition is for the purpose of simplicity and clarity and does not in itself dictate a relationship between the various exemplary embodiments and/or configurations discussed in the various Figures. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact. Finally, the exemplary embodiments presented below may be combined in any combination of ways, i.e., any element from one exemplary embodiment may be used in any other exemplary embodiment, without departing from the scope of the disclosure.

Additionally, certain terms are used throughout the following description and claims to refer to particular components. As one skilled in the art will appreciate, various entities may refer to the same component by different names, and as such, the naming convention for the elements described herein is not intended to limit the scope of the invention, unless otherwise specifically defined herein. Further, the naming convention used herein is not intended to distinguish between components that differ in name but not function. Additionally, in the following discussion and in the claims, the terms “including” and “comprising” are used in an open-ended fashion, and thus should be interpreted to mean “including, but not limited to.” All numerical values in this disclosure may be exact or approximate values unless otherwise specifically stated. Accordingly, various embodiments of the disclosure may deviate from the numbers, values, and ranges disclosed herein without departing from the intended scope. Furthermore, as it is used in the claims or specification, the term “or” is intended to encompass both exclusive and inclusive cases, i.e., “A or B” is intended to be synonymous with “at least one of A and B,” unless otherwise expressly specified herein.

With the advent of the Internet and mobile devices including smart phones, traditional advertising and promotion activities have been rapidly transformed to cover both on-line and off-line product and service promotions. The on-line world and the mobile technology world have been integrated into the traditional market, and have collectively become another communication channel between the provider and the purchaser of products or services. For the purpose of describing the present invention, it is understood that the term “product” includes any product or service that can be promoted.

On one hand, it is now possible to directly access a targeted customer or consumer base through new communication or presentation means such as emails, websites, SMS text messages, video content, and applications. On the other hand, it has become more difficult to evaluate the effectiveness of a particular promotion because the consumers have far more communication channels to receive the information about the promoted products.

It is a powerful tool to target a promotion to a group of selected consumers who are likely to have a serious interest in the promoted product. However, the interests of consumers are constantly changing. Thus the effectiveness of a promotion depends largely on the targeting process for determining the group of selected consumers. The targeting process not only requires significant information about the consumers in general, but the information must be correct and up-to-date. While many manufacturers and advertisers consider promotions to mobile devices to be one of the most effective and economical way to market their products, evaluating, reporting and improving the effectiveness of the mobile device product promotions remains a significant problem.

According to aspects of the present disclosure, a third party data set based on third party cookies or device identifiers, can be merged with a first party data set based on first party cookies and identifiers, and in turn used to refine a previously defined data set. An application for such method may include improving mobile device market research, and more specifically, to improve ad effectiveness tracking within a mobile application, for example. A third party data set can include information sufficient to determine mobile respondents that participated in one or more activities of interest, and used in combination with first party data to refine previously defined data sets regarding mobile device users. The activities of interest may include certain behaviors, such as mobile application usage or internet usage, or viewing certain content or exposure to online advertisement. An individual member identification tag associated with such mobile respondents can be used to determine characteristics of such mobile respondents. The characteristics may include demographic, psychographic and profile information. Info can be collected via surveys, stored in a tag, and associated with the individual member identification tag.

Third party data sets, such as those passively or actively collected by third party partners, may be correlated with first party data sets according to the present disclosure. Correlating data from a third party data set with a first party data set may, for example, enable cross platform analysis (i.e., merging data from online devices, mobile devices, location-based devices, and offline data sources). In a particular embodiment, using permission-based tracking technology such as cookies or device identifiers, the present disclosure enables automated tagging and monitoring of mobile device users' exposure to online information, including advertising campaigns. In turn, using correlated datasets from cross platforms, it is possible to target and invite unexposed and exposed mobile device users to participate in surveys, without interrupting the online experience of any of the mobile device users.

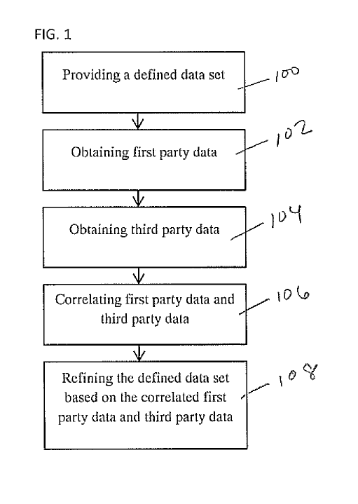

Turning now to FIG. 1, a flowchart is shown for a method of conducting mobile device market research into advertising effectiveness in accordance with an embodiment of the present disclosure. At step 100, the method can include providing a previously defined data set. The previously defined data set includes at least a list of mobile device respondents and related data from which survey panels may be selected based on chosen characteristics. At step 102, the method can include obtaining first party data for a subset of one or more mobile respondents from the list of mobile device respondents that participated in a predetermined activity. The predetermined activity may include certain behaviors, such as mobile application, particular hardware or internet usage, or viewing certain content. At step 104, the method can include obtaining third party data for the subset of one or more mobile respondents that participated in the predetermined activity. Obtaining the third party data can be performed by execution of a script, firing a beacon to check for the existence of a particular third party cookie, firing a tag to check for the existence of a particular third party cookie, or even obtaining the third party data directly from the third party. At step 106, the method can include correlating the first party data and the third party data. In an embodiment, the correlation may be based on a unique identifier associated with each individual mobile device, which is applied to both first party data and third party data. At step 108, the method can include refining the previously defined data set based on the correlated first party data and third party data. With the refined data set, a specific follow up action may be directed to one or more members of the list of mobile device respondents, such as directing a survey invitation, conducting further surveys, and online research, based on the outcomes from the steps of correlating and refining of the defined data set.

Data can be collected, correlated, and used to refine the predefined data set in a number of different ways using the permission-based cookie tracking technology available. Illustrative data flows are explained below, and are not intended to be limiting on the scope of the disclosure.

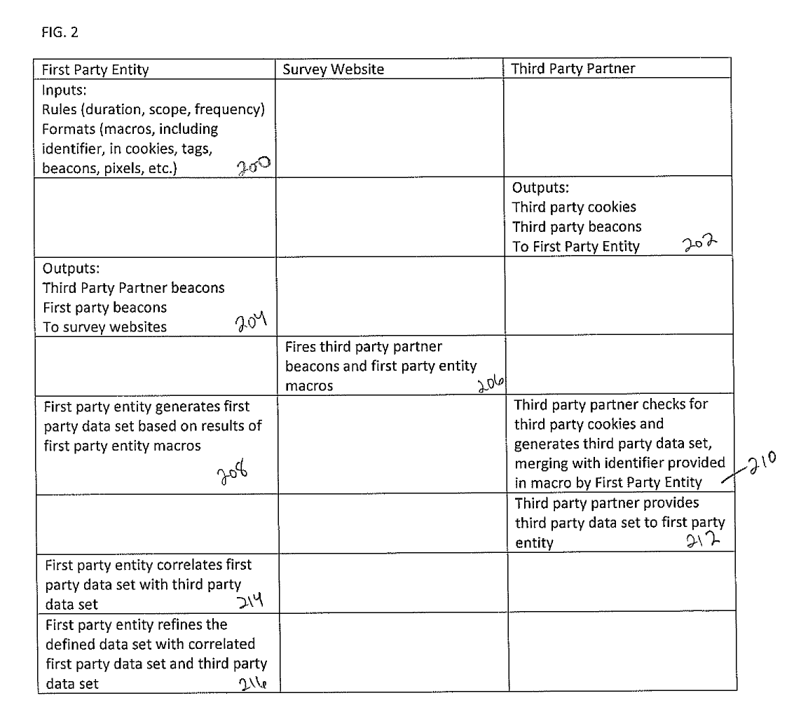

FIG. 2 shows a chart of a first example in accordance with an embodiment of the present disclosure, illustrating the electronic flow of data between parties during the method described with respect to FIG. 1. A first party entity exists which maintains a previously defined data set which includes at least a list of mobile device respondents and related data from which survey panels may be selected based on chosen characteristics. The first party entity contracts with a third party partner. The first party entity provides inputs to the system disclosed herein. The inputs include rules (such as, for example, duration, scope, frequency, etc. of a survey) as well as formats (such as, for example, macros that can include a unique identifier, as well as cookies, tags, beacons, pixels, and the like). The third party partner outputs to the first party entity third party cookies and/or third party beacons. The first party entity outputs to one or more survey websites its own first party macros and the third party partner beacons. When survey panel members access the survey website(s) using their mobile devices, the survey website(s) fire the third party partner beacons and the first party macros.

The first party entity generates the first party data set based on results of the first party entity macros, while the third party partner checks for its own third party cookies and generates the third party data set. The third party partner can use the unique identifier from the first party entity along with the third party data set to render the third party data set useable with the first party data set. The third party partner provides the third party data set to the first party entity. The first party entity correlates the first party data set with the third party data set, and using the correlated data sets, refines the previously defined data set.

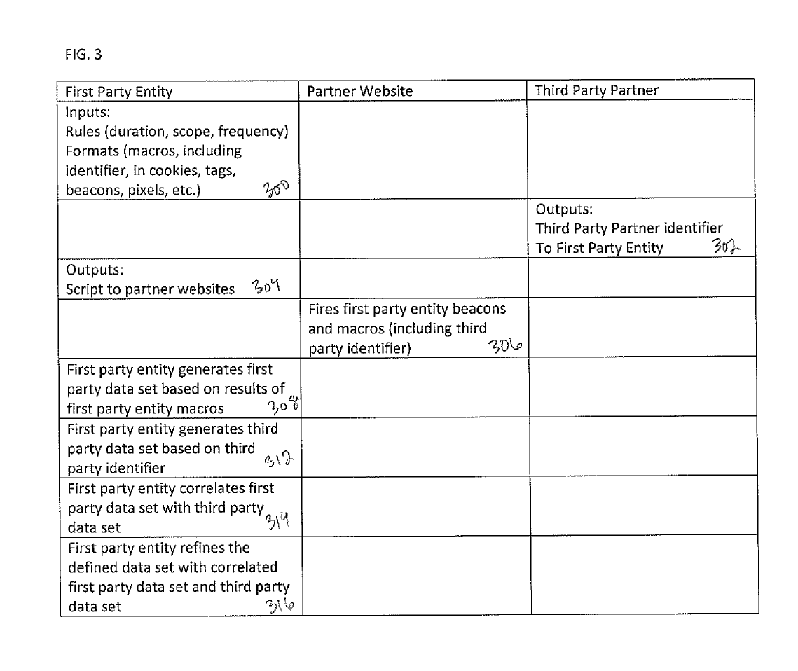

FIG. 3 shows a chart of a second example in accordance with an embodiment of the present disclosure. In the example shown in FIG. 3, cookies, both first and third party, may be indicative of various activities carried out on the mobile device by the mobile device respondent, either on a web browser or within a particular application. A first party entity exists which maintains a previously defined data set which includes at least a list of mobile device respondents and related data from which survey panels may be selected based on chosen characteristics. The first party entity contracts with a third party partner. The first party entity provides inputs to the system disclosed herein. The inputs include rules (such as, for example, duration, scope, frequency, etc. of a survey) as well as formats (such as, for example, macros that can include a unique identifier, as well as cookies, tags, beacons, pixels, and the like). The third party partner outputs to the first party entity a third party partner identifier.

The first party entity outputs to one or more partner websites its own first party macros (which have been merged to include the third party partner identifier). When survey panel members access the partner website(s) using their mobile devices, the survey website(s) fire the first party macros (including the third party partner identifier).

The first party entity generates the first party data set based on results of the first party entity macros, and the first party entity generates the third party data set (using the third party identifier). The first party entity correlates the first party data set with the third party data set, and using the correlated data sets, refines the previously defined data set.

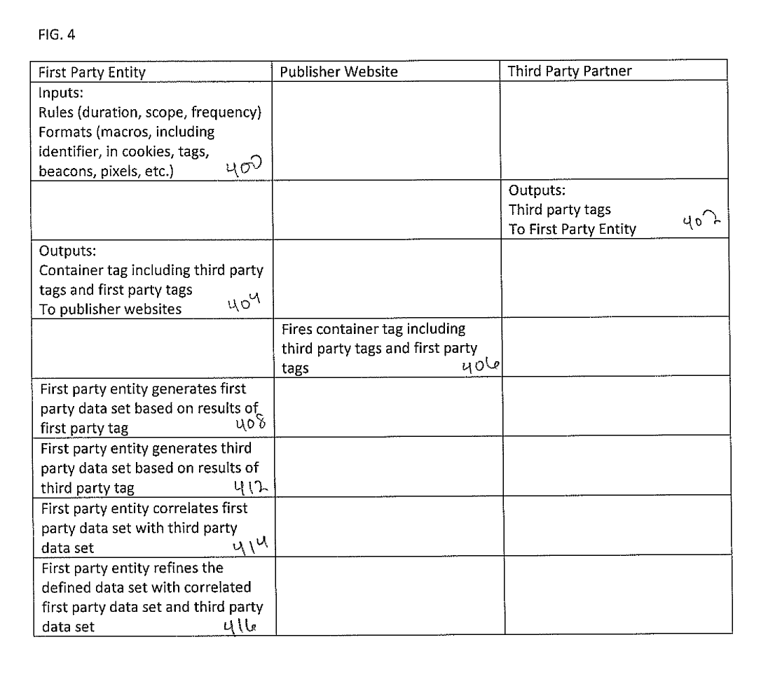

FIG. 4 shows a chart of a first example in accordance with an embodiment of the present disclosure. In the example shown in FIG. 4, cookies, both first and third party, may be indicative of various activities carried out on the mobile device by the mobile device respondent, either on a web browser or within a particular application. A first party entity exists which maintains a previously defined data set which includes at least a list of mobile device respondents and related data from which survey panels may be selected based on chosen characteristics. The first party entity contracts with a third party partner. The first party entity provides inputs to the system disclosed herein. The inputs include rules (such as, for example, duration, scope, frequency, etc. of a survey) as well as formats (such as, for example, macros that can include a unique identifier, as well as cookies, tags, beacons, pixels, and the like). The third party partner outputs to the first party entity a third party tag.

The first party entity outputs to a publisher website a container tag that includes its own first party macros as well as the third party tag. When survey panel members access the publisher website using their mobile devices, the publisher website fires the first party macros and the third party tags included in the container tag.

The first party entity generates the first party data set based on results of the first party tag, and the first party entity generates the third party data set based on results of the third party tag. The first party entity correlates the first party data set with the third party data set, and using the correlated data sets, refines the previously defined data set.

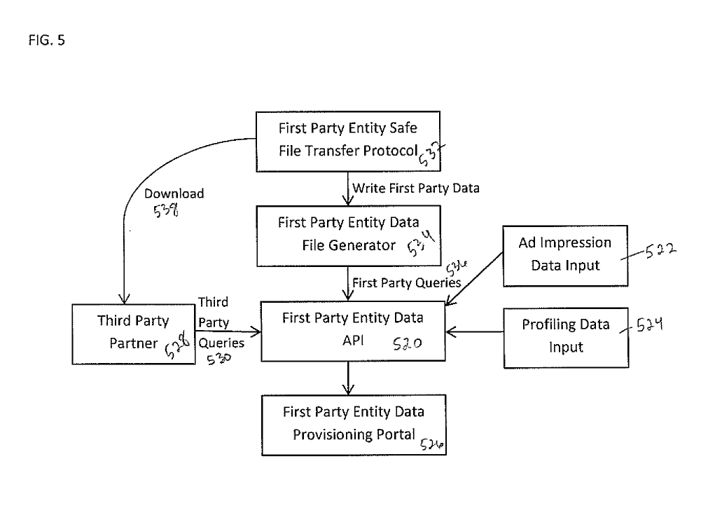

FIG. 5 shows a block diagram of a data transfer system that may be used for conducting mobile device market research into advertising effectiveness in accordance with an embodiment of the present disclosure. An API, or an application program interface, is a set of routines, protocols, and tool, for building software applications. A first party entity data API exists within the system of the present disclosure. Ad impression data and profiling data inputs are provided to the first party entity data API to define the data set. The first party entity data API can be used to provide data to a first party entity data provisioning portal, which is, in an embodiment, the user interface noted above. In some embodiments, third party partners may be provided access to the first party entity data API in order to make third party queries of the data set. The system writes first party data (obtained as described herein) via a first party entity safe file transfer protocol (SFTP) to a First Party Entity Data File Generator. The first party entity data file generator provides access to the first party entity data API in order to make first party queries of the data set. In an embodiment, the first party entity safe file transfer protocol can be downloaded to the third party partner to provide the first party data to the third party partner.

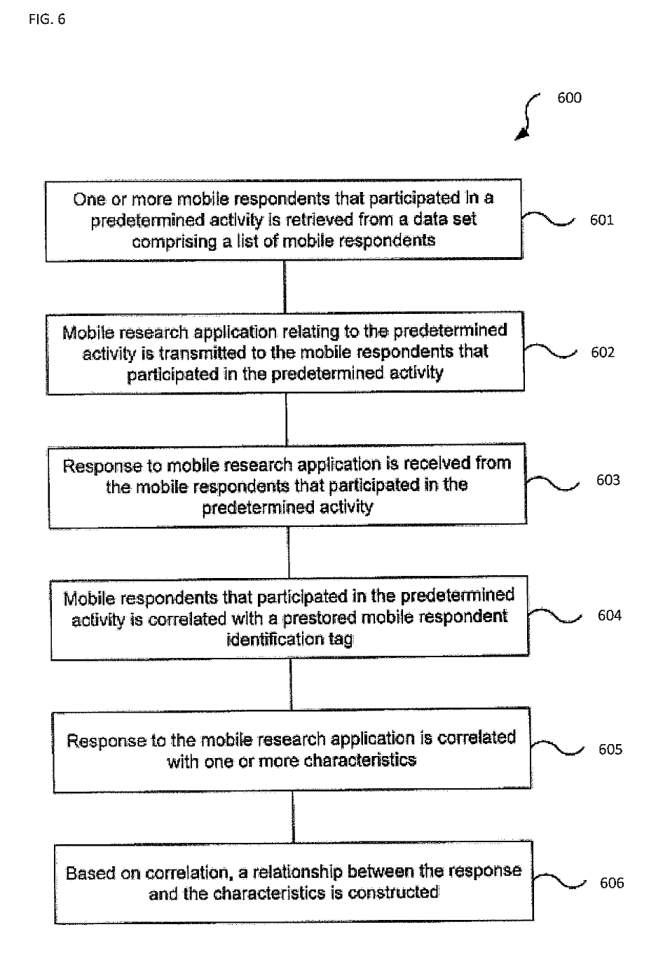

FIG. 6 illustrates functional blocks executed to perform a method of mobile respondent market research according to the concepts described herein. FIG. 6 illustrates functional blocks executed to perform method 600 of mobile respondent market research according to the concepts described herein. At step 601, one or more mobile respondents that participated in a predetermined activity is retrieved from a data set comprising a list of mobile respondents. At step 602, a mobile research application relating to the predetermined activity is transmitted to the one or more mobile respondents that participated in the predetermined activity. At step 603, a response to the mobile research application is received from the one or more mobile respondents that participated in the predetermined activity. At step 604, the one or more mobile respondents that participated in the predetermined activity is correlated with a pre-stored mobile respondent identification tag. The pre-stored mobile respondent identification tag comprises one or more characteristics of the one or more mobile respondents that participated in the predetermined activity. At step 605, the response to the mobile research application is correlated with the one or more characteristics. At step 606, based on the correlation, a relationship between the response and the one or more characteristics is constructed.

According to one embodiment, additional steps are performed. Such steps include retrieving, from the data set comprising a list of mobile respondents, one or more mobile respondents who have not participated in the predetermined activity, transmitting, to the one or more mobile respondents that have not participated in the predetermined activity, the mobile research application relating to the predetermined activity, receiving, from the one or more mobile respondents that have not participated in the predetermined activity, a response to the mobile research application, comparing the response of the one or more mobile respondents that participated in the predetermined activity to the response of the one or more mobile respondents that have not participated in the predetermined activity, and based on the comparison, determining the effectiveness of the predetermined activity.

According to certain aspects, the predetermined activity comprises viewing an advertisement, using an application installed on a mobile device, and/or visiting one or more websites on a mobile device.

According to various embodiments disclosed herein, data may be gathered using various different techniques. According to one embodiment, third party cookies or beacons are implemented on websites to facilitate gathering data from a third party data set. Generally, the implementation of cookie placement may be coordinated through a web User Interface (UI). When using a beacon, the system may indicate how often the beacon should fire (once a day, week, month per member, or only if a new cookie ID is received). At implementation, the system may indicate if the beacon only fires for a certain panel of members, i.e., mobile respondents, or all members. At implementation, the system may indicate when the beacon is active. At implementation, the system may activate macros which are passed via a tag (such as an encrypted member ID, for example).

In an embodiment, there may be an optional storage to store cookie IDs as well on a researcher's site to create a database with third parties, cookie IDs and member IDs for later data matches.

In an embodiment, beacons may check for the existence of third party cookies. If there is a third party cookie in place, then the system may, in an embodiment, provide the member ID directly to the third party partner. In order for the system to provide the member ID to the third party partner, an Application Program Interface (API) end point can be used. If there is no API end point available, then alternatively the system can store the match in the database and have an API/Service available to provide the data to the third party partner.

In an embodiment, the system may provide the encrypted member ID to a third party partner at the moment of exposure to a particular advertisement. The member ID may be provided if the member is opted-in for the particular service (i.e., has a cookie on their mobile device). The member ID may be provided through the tag from the third party or sent to an API.

Service/API functions include: In an embodiment, an API can be created for third party partners to receive member IDs after a match is identified using beacons. In addition to member IDs, third party partners may be able to use the API to access demographic data of the members where there is a match is made for cookie ID and member ID. The amount of demographic data available for the third party may be determined ahead of time.

In an embodiment, data may be provided by API, service, or File Transfer Protocol (FTP), each of which is well known in the art. The system can create blocks of profile data which can be selected to provide and make available through API. Profile data may include personal information such as age, gender, household income, education etc., employment information such as industry, business title etc., or other information, such as car ownership, house ownership, etc.

In an embodiment, third party tagging may be employed within the context of container tags. Third party tagging may include setting up a JavaScript tab with the ability to send container tags, make modifications to the system dashboard (i.e., user interface), make modifications to tagging guidelines, and tie third party data exchange/pixel approach (i.e. sample container approach).

In an embodiment, third party tagging is an option to wrap other tags in the system's container tag. As such, at the moment that an impression tag is loaded, the system will also load a third party tag. This means that the impressions from the third party will go through the first party system. The first party system may not only load the third party tag, but also pass ad-server variables (placement, campaign, creative, site).

In an embodiment, “retargeting” includes placing a third party cookie on a panel website, and then have members that have the third party cookie exposed to an advertisement for market research purposes, for example, have the members with the third party cookie receive a data stream from third party.

FIG. 6 illustrates functional blocks executed to perform method 600 of mobile respondent market research according to the concepts described herein. At step 601, one or more mobile respondents that participated in a predetermined activity is retrieved from a data set comprising a list of mobile respondents. At step 602, a mobile research application relating to the predetermined activity is transmitted to the one or more mobile respondents that participated in the predetermined activity. At step 603, a response to the mobile research application is received from the one or more mobile respondents that participated in the predetermined activity. At step 604, the one or more mobile respondents that participated in the predetermined activity is correlated with a pre-stored mobile respondent identification tag. The pre-stored mobile respondent identification tag comprises one or more characteristics of the one or more mobile respondents that participated in the predetermined activity. At step 605, the response to the mobile research application is correlated with the one or more characteristics. At step 606, based on the correlation, a relationship between the response and the one or more characteristics is constructed.

According to one embodiment, additional steps are performed. Such steps include retrieving, from the data set comprising a list of mobile respondents, one or more mobile respondents who have not participated in the predetermined activity, transmitting, to the one or more mobile respondents that have not participated in the predetermined activity, the mobile research application relating to the predetermined activity, receiving, from the one or more mobile respondents that have not participated in the predetermined activity, a response to the mobile research application, comparing the response of the one or more mobile respondents that participated in the predetermined activity to the response of the one or more mobile respondents that have not participated in the predetermined activity, and based on the comparison, determining the effectiveness of the predetermined activity.

According to certain aspects, the predetermined activity comprises viewing an advertisement, using an application installed on a mobile device, and/or visiting one or more websites on a mobile device.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

1. A method for conducting mobile device market research into advertising effectiveness, the method comprising:
providing a previously defined data set comprising a list of mobile device respondents and related data;
obtaining first party data for a subset of one or more mobile respondents from the list of mobile device respondents that participated in a predetermined activity;
obtaining third party data for the subset of one or more mobile respondents that participated in the predetermined activity;
correlating the first party data and the third party data; and
refining the previously defined data set based on the correlated first party data and third party data.

2. The method of claim 1, wherein the predetermined activity comprises: viewing an advertisement.

3. The method of claim 1, wherein the predetermined activity comprises: using an application installed on a mobile device.

4. The method of claim 1, wherein the predetermined activity comprises: visiting a website on a mobile device.

5. The method of claim 1, wherein the first party data comprises one or more of user provided profile data and gathered behavioral data.

6. The method of claim 1, wherein the third party data comprises one or more of social media data, point-of-sale data, impression data, user provided profile data, location data, GPS data, and passively gathered data.

7. The method of claim 1, wherein the obtaining the third party data is performed via an application program interface, service, or file transfer protocol.

8. The method of claim 1, wherein obtaining first party data further comprises firing a beacon configured to check for whether a first party cookie has been set at a given mobile device.

9. The method of claim 1, wherein obtaining third party data further comprises:
receiving a third party partner cookie from a third party; and
firing a beacon configured to check for whether a third party cookie has been set at a given mobile device.

10. The method of claim 1, wherein obtaining third party data further comprises:
receiving a third party identifier from a third party; and
firing a beacon configured to check for whether a given mobile device is associated with the third party identifier.

11. The method of claim 1, wherein obtaining third party data further comprises:
receiving a third party tag from a third party; and
firing a container tag configured with the third party tag, wherein the container tag is configured to check for whether a third party cookie has been set at a given mobile device.

12. The method of claim 1, further comprising selecting one or more survey panel members from the previously defined data set refined based on the correlated first party data and third party data.

13. The method of claim 1, further comprising executing a follow up action based on the refined data set.

14. A platform for conducting mobile device market research into advertising effectiveness, comprising:
a. A plurality of mobile devices, each mobile device associated with a mobile respondent; and
b. one or more computers and one or more storage devices storing instructions that are operable, when executed by the one or more computers, to cause the one or more computers to perform operations comprising:
providing a previously defined data set comprising a list of mobile device respondents and related data;
obtaining first party data for a subset of one or more mobile respondents from the list of mobile device respondents that participated in a predetermined activity;
obtaining third party data for the subset of one or more mobile respondents that participated in the predetermined activity;
correlating the first party data and the third party data; and
refining the previously defined data set based on the correlated first party data and third party data.

15. The platform of claim 14, wherein the predetermined activity comprises: viewing an advertisement.

16. The platform of claim 14, wherein the predetermined activity comprises: using an application installed on a mobile device.

17. The platform of claim 14, wherein the predetermined activity comprises: visiting a website on a mobile device.

18. The platform of claim 14, wherein the first party data comprises one or more of user provided profile data and gathered behavioral data.

19. The platform of claim 14, wherein the third party data comprises one or more of social media data, point-of-sale data, impression data, user provided profile data, location data, GPS data, and passively gathered data.

20. The platform of claim 14, wherein the third party data is obtained via an application program interface, service, or file transfer protocol.

21. The platform of claim 14, wherein the instructions that are further operable, when executed by the one or more computers, to cause the one or more computers to perform operations, wherein obtaining first party data further comprises firing a beacon configured to check for whether a first party cookie has been set at a given mobile device.

22. The platform of claim 14, wherein the instructions that are further operable, when executed by the one or more computers, to cause the one or more computers to perform operations, wherein obtaining third party data further comprises:
receiving a third party partner cookie from a third party; and
firing a beacon configured to check for whether a third party cookie has been set at a given mobile device.

23. The platform of claim 14, wherein the instructions that are further operable, when executed by the one or more computers, to cause the one or more computers to perform operations, wherein obtaining third party data further comprises:
receiving a third party identifier from a third party; and
firing a beacon configured to check for whether a given mobile device is associated with the third party identifier.

24. The platform of claim 14, wherein the instructions that are further operable, when executed by the one or more computers, to cause the one or more computers to perform operations, wherein obtaining third party data further comprises:
receiving a third party tag from a third party; and
firing a container tag configured with the third party tag, wherein the container tag is configured to check for whether a third party cookie has been set at a given mobile device.

25. The platform of claim 14, wherein the instructions that are further operable, when executed by the one or more computers, to cause the one or more computers to perform operations including executing a follow up action based on the refined data set.
